(19) United States
(12) Patent Application Publication
(10) Pub. No.: US 2023/0183827 A1
(43) Pub. Date: Jun. 15, 2023

(54) METHODS OF METAL EXTRACTION

(71) Applicant: Bal Mukund Dhar, Lincoln, MA (US)

(72) Inventor: Bal Mukund Dhar, Lincoln, MA (US)

(21) Appl. No.: 18/066,262

(22) Filed: Dec. 14, 2022

Related U.S. Application Data
(60) Provisional application No. 63/289,141, filed on Dec. 14, 2021.

(51) Int. Cl. C21B 15/00; C22C 33/00; C22B 3/06; C22B 5/00; C25C 1/06

(52) U.S. Cl. CPC C21B 15/006; C22B 3/06; C22B 5/00; C22C 33/00; C25C 1/06

(57) ABSTRACT

Embodiments described herein relate to methods of metal extraction from their ores and conversion of ores to metal carbonates for chemical storage of Carbon dioxide in mineral form. In some embodiments, metal alloys are produced directly by co-extraction of metals from a combination of the ores of respective metals in the alloy or from a combination of the oxides of respective metals.

### CROSS REFERENCE TO RELATED APPLICATIONS

The present application claims priority to U.S. Provisional Pat. Application No. 63/ 289,141 entitled “METHOD FOR CARBON DIOXIDE SEQUESTRATION AND SUBSEQUENT METAL EXTRACTION” filed Dec. 14, 2021 the entire contents of which are incorporated herein by reference.

### TECHNICAL FIELD

Embodiments described herein relate to methods of metal extraction from their ores and conversion of ores to carbonates for chemical storage of Carbon dioxide in mineral form.

### BACKGROUND

Steel has powered the rise of human civilization and ranks among the most important engineering materials. Currently, Iron and Steel industry consumes 36 Quadrillion BTUs (Quads) of energy per year (7% of World Energy Consumption) leading to 3.5 billion tons of CO2 emission annually (7% of total). The Blast Furnace process and DRI process for the production of Iron by reduction of Iron Ore with Carbon at high temperatures lead to large CO2 emissions directly contributing 3% of global CO2 emissions (1.5 billion tons annually). Direct reduction of oxide ore by Hydrogen can partially reduce the CO2 emissions but the reduction reaction is endothermic and occurs at higher temperatures leading to CO2 emissions if renewable sources are not used for providing process heat. Similar challenges exist for extraction of nonferrous metals from their ores. Lowering the reduction temperature and energy requirements for production of Iron can be achieved by a two-step reduction approach to first convert the ore of the metal into an intermediate compound which is then reduced to solid metal in second step.

### SUMMARY

Embodiments described herein relate to extraction of metals from their respective ores. In some aspects, the methods described herein relate to extraction of Iron from Hematite, Magnetite or other Oxide ores of Iron. In some aspects, the processes described herein related to sequestration of CO2 in the form of Metal Carbonates, and especially Ferrous Carbonate which can later be used to extract Iron via a reduction reaction.

In some aspects, the method comprises dissolving an oxide ore of a metal in an acid solution to form a soluble product comprising metal ions of higher and lower valency in aqueous solution, converting the higher valent ions in solution to lower valent ions in solution via a reduction reaction, and reducing the lower valent ions in solution to metal. In some aspects, the metal ions in solution are precipitated to form an insoluble compound. In some aspects the insoluble compound is a Metal Carbonate. In some aspects, the lower valent cation is precipitated to form the insoluble metal carbonate by reacting it with at least one of sodium carbonate, sodium bicarbonate, as-mined or processed trona rock or a combination thereof. In some aspects, the insoluble compound is reduced to respective metal. In some aspects, the reduction of insoluble compound to the respective metal is performed by reaction with at least one of hydrogen, carbon monoxide, carbon, methane, hydrogen plasma, plasma reformed methane or a combination thereof. In some aspects, reduction of the metal carbonate is performed at a temperature between about 300° C. and about 700° C. In some aspects, metal formed by reduction of the insoluble metal carbonate is a metal powder in the form of microparticles or nanoparticles having a spherical morphology or an irregular morphology. In some aspects the method of extraction of metal is a closed loop process. In some aspects the metal carbonate is stored as a means of chemical sequestration of CO2.

In some aspects, the method comprises dissolving an oxide ore of iron in an acid solution to form a soluble product comprising ferric ions in solution, converting the ferric ions in solution to ferrous ions in solution via a reduction reaction, precipitating the ferrous ion in solution as an insoluble ferrous compound and reducing the insoluble ferrous compound to solid iron. In some aspects, the solution of ferric ion is reduced to a solution of ferrous ion by reacting it with iron in an acidic environment. In some aspects, the solution of ferric ion is reduced to a solution of ferrous ion by electrochemical reduction in a redox flow cell. In some aspects, the insoluble ferrous compound is Ferrous Carbonate. In some aspects the Ferrous Carbonate is precipitated by reacting the solution of ferrous ions with at least one of sodium carbonate, sodium bicarbonate, trona rock or a combination thereof. In some aspects, the reduction of insoluble Ferrous compound to the Iron is performed by reaction with at least one of hydrogen, carbon monoxide, carbon, methane, hydrogen plasma, plasma reformed methane or a combination thereof. In some aspects, the reduction of insoluble ferrous compound is performed at a temperature between about 300° C. and about 700° C. In some aspects, the iron formed by reduction of insoluble ferrous compound is powdered iron in the form of microparticles or nanoparticles having a spherical morphology or irregular morphology. In some aspects, the iron formed by reduction of insoluble ferrous compound is melted and cast into ingots and other products. In some aspects the method of extraction of Iron is a closed loop process. In some aspects, the Ferrous Carbonate is stored as a means of chemical sequestration of CO2.

In some aspects, the method of forming metal alloys from ores comprises mixing ores of different metals in a predetermined ratio to form a mixed ore, reacting a predetermined, quantity of ores of different metals with an acid solution to form a soluble product comprising metal ions of different metals in an aqueous solution, converting the higher valent metal ions in solution to lower valent metal ions in solution via a reduction reaction precipitating the lower valent metal ions of different metals in solution to form insoluble mixed metal carbonate, and reducing the mixed metal carbonate to form a metal alloy. In some aspects, the lower valent cation is precipitated to form the insoluble mixed metal carbonate by reacting it with at least one of sodium carbonate, sodium bicarbonate, as-mined or processed trona rock or a combination thereof. In some aspects, the reduction of the mixed metal carbonate to the metal alloy is performed by reaction at elevated temperature with at least one of hydrogen, carbon monoxide, carbon, methane, hydrogen plasma, plasma reformed methane or a combination thereof. In some aspects, the reduction of the mixed metal carbonate is performed at a temperature between about 300° C. and about 700° C. In some aspects, the method is a closed loop process. In some aspects, the mixed alloy formed by reduction of insoluble mixed metal carbonate is powdered metal alloy in the form of microparticles or nanoparticles having a spherical morphology or irregular morphology. In some aspects, the insoluble mixed metal carbonate and the metal alloy have atomic level of mixing of different metal elements.

In some aspects, the methods described herein for the extraction of metals or their alloys thereof, are closed loop processes such that most of the byproducts are consumed to regenerate the reagents or ingredients needed for the various steps in the in the process. In some aspects, the closed loop process for extraction of iron from its oxide ores as described herein leads to the emission of only water when Hydrogen is used to reduce the Ferrous Carbonate to Iron, according to some embodiments. Therefore, the closed loop processes described herein lead to extraction of Iron from its oxide ores at significantly lower temperatures than direct reduction of the same ores.

### BRIEF DESCRIPTION OF THE DRAWINGS

FIG. 1 shows a closed loop process for extraction of a metal, according to an embodiment.

FIG. 2 shows a closed loop process for the extraction of Iron, according to an embodiment.

FIG. 3 shows an alternative process for extraction of Iron, according to an embodiment.

FIG. 4 shows an alternative process for the extraction of Iron from its oxide ores, according to an embodiment.

FIG. 5 shows an alternative process for the extraction of Iron, according to an embodiment.

FIG. 6. shows an alternative process for the extraction of Iron, according to an embodiment.

FIG. 7 shows thermochemical data for various steps for the extraction of Iron, according to an embodiment.

### DETAILED DESCRIPTION

Metal Extraction from its Ores have been practiced for millenia and has been the backbone of human civilization. Traditional metallurgical processes for production of Metals typically use Carbon or Carbon Monoxide to reduce the ore to metal at high temperature. Consequently, metal extraction is an energy intensive process with CO2 emission due to reduction reaction and also due to the process heat requirements. Mitigation of CO2 emissions can be done using alternative reducing agents and alternative extraction methods to perform reduction of ore to metal at lower temperatures.

Iron and Steel ranks among the most important engineering materials. Currently, Iron and Steel industry consumes 36 Quadrillian BTUs(Quads) of energy per year (7% of World Energy Consumption) leading to 3.5 billion tons of CO2 emission annually (7% of total). The Blast Furnace process is the predominant process for the production of Iron by reduction of Iron Ore with Carbon. High temperatures (1500-1900° C.) needed for the process are the key reasons for the large CO2 emissions contributing 3% of global CO2 emissions (1.5 billion tons annually). In some embodiments, the methods disclosed herein present a low energy, closed loop process for Iron making by direct reduction with Hydrogen at low temperatures leading to 70-80% reduction in CO₂ emissions and 75% gain in energy efficiency compared to the blast furnace process of iron making. The methods disclosed herein, if fully adopted at large scale by the industry, can prevent 1.2 billion tons of CO2 emissions annually, 11 Quads of annual energy savings and would lead to an annual cost savings of >$50 Billion to the industry due to savings in energy, material costs (high quality coke etc) and process costs.

An additional problem pertaining to CO2 emissions relates to storing CO2 emitted by industrial processes and human activity. In some embodiments, variations of methods described herein provide ways for capture and chemical storage of CO2 in the form of Metal Carbonates. In some embodiments, variations of methods described herein provide ways for capture and chemical storage of CO2 by converting oxide ores of iron into Ferrous Carbonates in a facile manner. Oxide Ores of Iron, particularly Hematite and Magnetite, with their annual mining production and usage at ~ 2 billion tons are good candidates for CO2 mineralization because of abundance but also due to its insoluble and stable carbonate, Ferrous Carbonate (FeCO₃).

The methods describe herein have been shown for oxide-based Iron ores but also be used for oxide ores of other metals including, but not limited to, Nickel, Copper, Manganese, Chromium, Molybdenum, Vanadium, Zinc, Cobalt and other metals to store CO₂ in the form of carbonate which can subsequently be used for extraction of respective metals. The processes described herein are conducive for Iron Ores because reduction of Ferrous Carbonate by Hydrogen leads to metal formation at lower temperatures (300-500° C.) compared to the traditional industrial processes for reduction of Iron Ore by Carbon and Carbon Monoxide to Iron and also the direct reduction of oxide based Iron Ores to Iron by H₂ reduction.

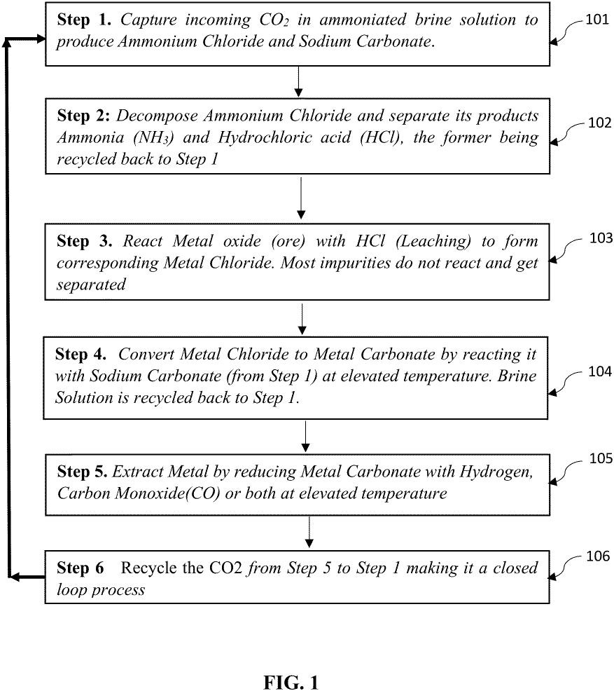

FIG. 1 shows a closed loop process of extraction of an oxide ore of a metal to form a corresponding metal. The process steps 101 to 106 describe the closed loop process wherein the input ingredients are the oxide ore of a metal and the H₂ gas as a reducing agent while other inputs and byproducts for different steps 101 to 106 are respectively produced and utilized with the closed loop process. The process step 101 involves capturing CO₂ into ammoniated brine solution (NH3+ NaCl mixture) to form Ammonium Chloride and Sodium Bicarbonate (well-known Hou’s process which is a variation of Solvay process). In some embodiments a portion of the Sodium Bicarbonate thus produced can be heated at temperature between about 50° C. to about 200° C. to produce Sodium Carbonate which is optional. In some embodiments, chloride salts of alkali metals (Li, K, Cs) and alkaline earth metals (Mg, Ca, Ba, Sr) may be used instead of sodium chloride. In some embodiments, methanolamine, ethanolamine, an alkyl amine or an aromatic amine may be used instead of Ammonia. In some embodiments, the Sodium Bicarbonate is separated from the solution containing Ammonium Chloride and Sodium Bicarbonate by evaporating the solution to precipitate and crystallize Sodium BiCarbonate using standard industrial methods.

Process step 102 involves heating and subliming the ammonium chloride crystallized from step 101 at temperatures between about 300° C. and 700° C. in the presence of a catalyst to separate it into Ammonia and HCl. The Ammonia separated from the In some embodiments, the ammonium chloride vapor is passed over a Nickel chloride catalyst at temperature above 300° C. to trap Ammonia while HCl vapor is condensed and collected. The trapped Ammonia is liberated by further catalyst at higher temperatures and recycled back to Step 101. In some embodiments, the MgCl2 or CaCl2 may be used to separate Ammonia and HCl and the former is recycled to Step 101. In some embodiments, Ammonium Chloride is reacted with MgO (or CaO) at temperature between 100° C. and 400° C. to form MgCl₂ (or CaCl₂) and Ammonia (recycled to step 101). In some embodiments, MgCl₂(or CaCl₂) so formed is reacted with steam at temperature between about 500° C. and about 700° C. to form MgO (or CaO) and HCl. In some embodiments, Ammonium Chloride is separated into Ammonia and HCl using electrodialysis in an electrodialysis stack.

The HCl produced in step 102 is utilized in step 103 to react metal oxide ore to form metal chloride solution. In some embodiments, the concentration of the HCl solution may be between 1 M and 0.01 M. In some embodiments, the reaction in step 103 may be performed at ambient temperature. In some embodiments, the reaction is step 103 may be performed at an elevated temperature. In some embodiments, the reaction is step 103 may be performed at a temperature about 30° C. and about 200° C. In some embodiments, the step 103 is performed as a leaching process where the HCl solution is poured on the metal oxide ore the most of the impurities such as Silica, alumina, sulfur, phosphorus, and other non-oxide impurities do not react with HCl to enter the solution phase and are therefore separated out by filtration system.

In some embodiments, the oxide ore used in Step 103 may be an ore of a single metal. In some embodiments, the oxide ore may be an ore containing more than one metal. In some embodiments, a predetermined ratio of oxide ores of same or different metals or combination of metals may be used to extract the metals alloys after going through the processing from steps 101-105. In some embodiments the metal alloys so produced may have a homogenous distribution of metals. In some embodiments, the alloys so produced may have different elements atomically mixed. In some embodiments, the metal alloys so produced may have a heterogeneous distribution of alloys. In some embodiments, the metal alloys so produced using methods described herein may have a homogeneous distribution of different phases distributed within a metal matrix or an alloy matrix. In some embodiments, the metal or alloys produced using the methods described herein may be in powdered form with particle size between 1 nm and 2 mm. The metal oxide ores may be chosen from ores of metals including, but no limited to, Nickel, Copper, Manganese, Chromium, Molybdenum, Zinc, Cobalt, Vanadium, Niobium, Zirconium, Titanium, Iron, Zirconium, Niobium, Uranium, Thorium, Cerium, Praseodymium, Neodymium, Samarium, Erbium, Gadolinium, Dysprosium and other post-transition metals, Lanthanides and Actinides etc.

In some embodiments, the metal of interest in the oxide ore may be in a higher valent state. In such a case, the higher valent metal cation is reduced to a lower valent metal cation (not shown in the FIG. 1). In some embodiments, the higher valent cation is reduced to a lower valent cation by reduction in an electrochemical cell. In some embodiments, the electrochemical reduction of higher valent metal cation to a lower valent metal cation is performed in an electrochemical cell. In some embodiments, the reduction of higher valent metal cation to a lower valent metal cation is performed via chemical reduction. In some embodiments, the reduction of higher valent metal cation to a lower valent metal cation is done by reacting with chlorobenzene to dichlorobenzene. In some embodiments the solution of lower valent metal cation may be stored in an oxygen free environment to keep it from oxidizing back to higher valent metal cation.

While not shown in the FIG. 1, in some embodiments the chloride ion can be replaced by another anion. In some embodiments the chloride ion may be replaced by a sulfate ion, nitrate ion, perchlorate ion or another anion of greater ionic strength than the chloride ion. Such anions can be replaced by adding the corresponding acid to the chloride solution of the metal cation and heating the solution to collect the hydrochloric acid as a vapor. In some embodiments, other anions can co-exist in solution with the chloride ion by addition of acid corresponding to the particular cation. In some embodiments, the pH of the solution can be adjusted to be lower than the 7. In some embodiments, the pH of the solution is between 2 and 7. In some embodiments, the additional anions added to the chloride solution of metal cation may be of lower strength than the chloride ion. In some embodiments, the additional anions may be added as a solution of corresponding acid. In some embodiments, the additional anion may be added as the salt of the anion with a metal. In some embodiments, the metal may be an alkali metal, an alkaline earth metal or a transition metal or a metal common to the metal of interest in the ore. In some embodiments, the chloride ion is partially or fully replaced by another anion by electrodialysis. In some embodiments the chloride ion may be replaced by the sulfate ion.

In process Step 104, the solution obtained in the Step 103 is converted to a metal carbonate by reacting it with a solution of at least one of sodium carbonate, sodium bicarbonate or both as obtained from the Step 101. In some embodiments, an extra quantity of sodium carbonate, sodium bicarbonate or their combination may be added to the solution. In some embodiments, this reaction is carried out at temperature between about 25° C. and about 350° C. In some embodiments, the pH of the reaction mixture is between 2 and 7 for some metal chloride solutions to adjust (or increase) the rate of reaction and to suppress parasitic reactions. In some embodiments, the metal carbonate formed by the reaction is precipitated out from the solution. In some embodiments, the seed crystals of metal carbonate of interest are added to the reaction mixture to increase the rate of nucleation or growth or both, and hence increase the rate of the reaction. In some embodiments, the seed crystals of another material are added to the solution to achieve a higher rate of the reaction. In some embodiments, another organic or inorganic materials in solid, liquid or gaseous form may be added to the reaction vessel to impede the formation of non-carbonate precipitates during the reaction. For instance, ammonia may be bubbled through the solution to impede the formation of a metal hydroxide that may precipitate before carbonate or co-precipitate with the metal carbonate. In some embodiments, a solution of sulfuric acid may be added to the reaction vessel to impede the formation of a metal hydroxide that may precipitate before the metal carbonate or co-precipitate with the metal carbonate. In some embodiments, the metal carbonate precipitate may be filtered, washed and dried. In some embodiments, a portion of the metal carbonate precipitate may be used as a seed crystal for another batch of the reaction. In some embodiment, the seed crystals may have an amorphous structure or a partial crystalline and amorphous nature. In some embodiments, the process step 104 is conducted in an oxygen free environment to prevent the oxidation of lower valent metal cation into a higher valent metal cation. In some embodiments the pH in the reaction vessel is maintained at an acidic level to prevent the oxidation of a lower valent metal cation into a higher valent cation. In some embodiments, an inert gas such as N2, Ar or He may be bubbled through the reaction vessel during the reaction.

In many ores, limestone or dolomite are impurities in the ore which may enter the solution at Step 103. However, due to the energetics of their reaction with sodium carbonate or bicarbonate may not be favorable enough at the range of conditions of step 104 to convert them back to insoluble precipitate. However, in some embodiments, impurities of at least one of CaCO3, MgCO3, SiO2, Carbon may be deliberately added to the solution in powder form. In some embodiments, such impurities may be act as seed crystals for the precipitation of metal carbonate during step 104. In some embodiments, such impurities may be added for further processing requirements during step 105 or purification of the metal formed after step 105. In some embodiments, the carbon added to the solution may be amorphous carbon, nano-carbon, graphene, carbon nanotubes, fullerenes or other forms of carbon. In some embodiments, Zirconium Oxide or Yttrium oxide or Tungsten oxide micro- or nano-particles may be added to the reaction mixture as seed crystals or to aid further processing (in Step 105 or after step 105) or to control the properties of the metals so produced. In some embodiments, oxide micro- or nano-particles of other metals such as Ca, Mg, Li, Si, Sr, Ba, K, Ti, V, Cr, Mn, Fe, Co, Ni, Cu, Zn, Zr, Mo, Nb, Ce B, Al, Sn etc. may be added as to the reaction mixture as seed crystals or to aid further processing (in Step 105 or after step 105) or to control the properties of the metals so produced. In some embodiments, the impurities act as nucleation and growth sites for metal carbonates formed in step 104. In some embodiments, these oxide or carbonate materials in nano- or micro-from may participate in the Step 5 as a catalyst or reactant.

In some embodiments the Metal Carbonate so formed has a particle size in the range between about 1 nm and about 100 nm. In some embodiments the Metal Carbonate so formed has a particle size in the range between about 1 nm and about 500 nm. In some embodiments the Metal Carbonate so formed has a particle size in the range between about 1 nm and about 1 micron. In some embodiments the Metal Carbonate so formed has a particle size in the range between about 10 nm and about1micron. In some embodiments the Metal Carbonate so formed has a particle size in the range between about 100 nm and about 5 microns. In some embodiments the Metal Carbonate so formed has a particle size in the range between about 100 nm and about 10 microns. In some embodiments the Metal Carbonate so formed has a particle size in the range between 100 nm and 100 microns. In some embodiments the Metal Carbonate so formed has a particle size of at least 50 nm. In some embodiments the Metal Carbonate so formed has a particle size of at least 500 nm. In some embodiments the Metal Carbonate so formed has a particle size of at least 1 micron. In some embodiments the Metal Carbonate so formed has a particle size of at least 5 microns. In some embodiments the Metal Carbonate so formed has a particle size of at most 1 micron. In some embodiments the Metal Carbonate so formed has a particle size of at most 10 microns. In some embodiments the Metal Carbonate so formed has a particle size of at most 100 microns. In some embodiments, the particle size distribution is a bimodal distribution.

In Process step 105, the metal carbonate prepared during the prior reaction step 104 is reduced to the metal using a reducing agent in a reactor or furnace. In some embodiments, H₂ is used as a reducing agent. In some embodiments, the reduction of the metal carbonates to respective metal are done in a temperature range between about 200° C. and about 400° C. In some embodiments, the reduction of the metal carbonates to respective metal are done in a temperature range between about 200° C. and about 1000° C. In some embodiments, the reduction of the metal carbonates to respective metal are done in a temperature range between about 200° C. and about 800° C. In some embodiments, the reduction of the metal carbonates to respective metal are done in a temperature range between about 200° C. and about 700° C. In some embodiments, the reduction of the metal carbonates to respective metal are done in a temperature range between about 200° C. and about 600° C. In some embodiments, the reduction of the metal carbonates to respective metal are done in a temperature range between about 200° C. and about 500° C. In some embodiments, the reduction of the metal carbonates to respective metal are done at a temperature of at least 200° C. In some embodiments, the reduction of the metal carbonates to respective metal are done at a temperature of at least 300° C. In some embodiments, the reduction of the metal carbonates to respective metal are done at a temperature of at least 400° C. In some embodiments, the reduction of the metal carbonates to respective metal are done at a temperature of at least 200° C. In some embodiments, the reduction of the metal carbonates to respective metal are done at a temperature of at most 500° C. In some embodiments, the reduction of the metal carbonates to respective metal are done at a temperature of at least 600° C. In some embodiments, the reduction of the metal carbonates to respective metal are done at a temperature of at least 700° C. In some embodiments, the reduction of the metal carbonates to respective metal are done at a temperature of at least 800° C. In some embodiments, the reduction of the metal carbonates to respective metal are done at a temperature of at least 900° C. In some embodiments, the reduction of the metal carbonates to respective metal are done at a temperature of at least 1000° C.

In some embodiments, the temperature of the reduction of an alloy carbonate is intermediate to the temperature of reduction of metal carbonate with highest temperature and the temperature of reduction of metal carbonate with lowest temperature. In some embodiments, the temperature of the reduction of an alloy carbonate is lower than the lowest temperature of reduction of metal carbonate present in the alloy carbonate.

In some embodiments, at least one of Carbon Monoxide, Carbon, Coke, Coal, Methane, Ethane, Ethylene, Acetylene, Metal Hydride, Hydrogen can be used alone or in combination. In some embodiments, Hydrogen can be mixed with other reducing agents mentioned above to regulate the temperature range of the reduction reaction or to control the amount of heat generated/consumed in the reaction (for example, to convert the H₂ reduction of metal oxide from endothermic to exothermic). In some embodiments, other reducing agents can be mixed with H₂ in the concentration range between about 5% and about 95% of the total. In some embodiments, Carbon Monoxide is mixed with H₂ in the concentration range between about 5% and about 95% of the total. In some embodiments, Methane is mixed with H₂ in the concentration range between about 5% and about 95% total. In some embodiments Syngas is used as a reducing agent. In some embodiments Water Gas is used as a reducing agent. In some embodiments Ammonia is used as a reducing agent.

In some embodiments, the reduction reaction in step 105 is done at atmospheric pressure. In some embodiments the reduction reaction is done at pressures in the range between about 1 mPa to about 10⁴ kPa. In some embodiments the partial pressure of the reducing gases in the reaction can be varied. In some embodiments, the partial pressure of the reducing gas in the reaction is between about 1 mPa and about 1 Pa. In some embodiments, the partial pressure of the reducing gas in the reaction is between about 1 mPa and about 10 Pa. In some embodiments, the partial pressure of the reducing gas in the reaction is between about 1 mPa and about 100 Pa. In some embodiments, the partial pressure of the reducing gas in the reaction is between about 100 Pa and about 1 kPa. In some embodiments, the partial pressure of the reducing gas in the reaction is between about 100 Pa and about 5 kPa.

In the final step 106, the CO₂ and H₂O produced in the step 105 are separated from via partial or complete condensation of the water vapor. The resultant CO₂ after separation or the mixture of CO₂ and H₂O after partial separation is recycled back in to step 101 to make it a closed loop process. In some embodiments, the CO₂ and H₂O produced in step 105 is recycled back as such to reaction 101 making it a closed loop process. In some embodiments, additional CO₂ is mixed with output of step 105 to make up for any shortfall in the CO₂ required for the next cycle. In some embodiments, variations may be made to the closed loop process to add extra ingredients or emit extra by-products to make up for the shortfall or to vary the composition or reactants at various steps 101 to 105.

In some embodiments, the process shown in FIG. 1 is truncated at step 104 to store the metal carbonate as such. In some embodiments the metal carbonate so formed is stored in the same mine from where the metal oxide ore is mined. In some embodiments, the metal carbonate so stored can be used as a source of CO₂ at a later time by heating the metal carbonate, reacting the metal carbonate with an acid or through other chemical reactions or electrochemical reactions.

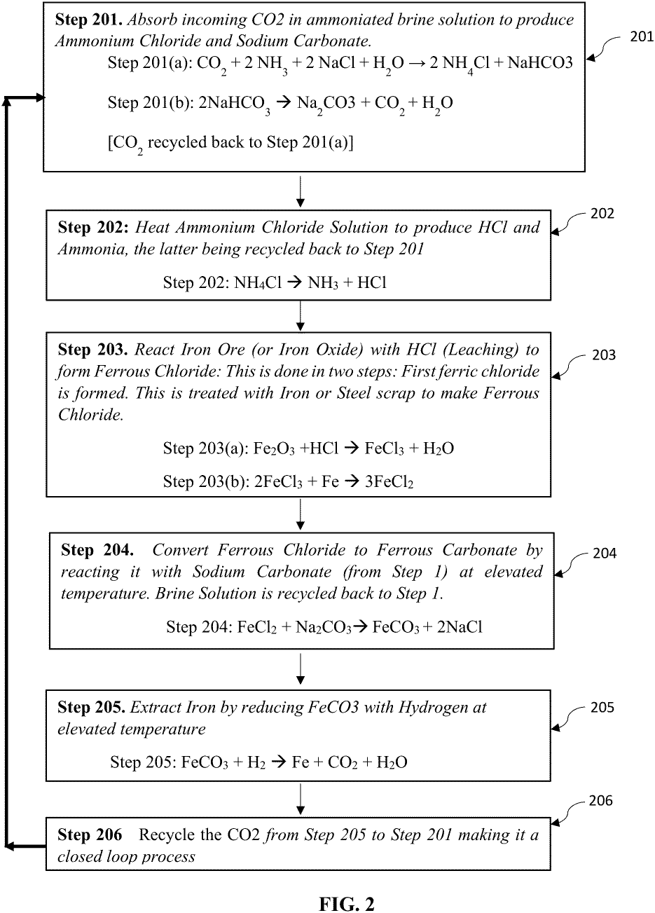

FIG. 2 shows a closed loop process for the extraction/production of Iron from oxide based Iron ores: Hematite (Fe₂O₃) and Magnetite (Fe₃O₄). But it can be applied to any oxide ore of Iron. In some embodiments, an oxide of Iron can be used instead of an oxide ore of Iron. In some embodiments, alloys of Iron with other metals may be formed if a mixture of oxide ores or oxides of different metals are mixed with oxide ores of iron. In some embodiments, Iron powder with the size range between 1 nm and 2 mm can be obtained using the processes described in FIG. 2. In some embodiments, alloy powders of Iron with other metals having atomic level of mixing of various metals may be achieved by using oxide ores (or oxides) of different metals mixed with oxide ores (or oxides) of Iron. The oxide ores (or oxides) may be chosen from ores (or oxides) of metals including, but no limited to, Nickel, Copper, Manganese, Chromium, Molybdenum, Zinc, Silicon, Cobalt, Vanadium, Niobium, Zirconium, Titanium, Zirconium, Niobium, Uranium, Thorium, Cerium, Praseodymium, Neodymium, Samarium, Erbium, Gadolinium, Dysprosium and other post-transition metals, Lanthanides and Actinides etc.

In some embodiments the alloy powders so formed have a particle size in the range between 1 nm and 2 mm. In some embodiments, the iron powder or alloy powder formed has a spherical morphology. In some embodiments, the iron powder or alloy powder formed using has a dendritic morphology. In some embodiments, the iron powder or alloy powder formed using has a irregular morphology. In some embodiments the iron powder or alloys powder has a particle size in the range between about 1 nm and about 100 nm. In some embodiments the iron powder or alloys powder has a particle size in the range between about 10 nm and about 100 nm. In some embodiments the iron powder or alloys powder has a particle size in the range between about 50 nm and about 500 nm. In some embodiments the iron powder or alloys powder has a particle size in the range between about 100 nm and about 1 micron. In some embodiments the iron powder or alloys powder has a particle size in the range between about 100 nm and about 10 microns. In some embodiments the iron powder or alloys powder has a particle size in the range between about 1 micron and about 100 microns. In some embodiments the iron powder or alloys powder has a particle size in the range between about 1 micron and about 100 microns. In some embodiments the iron powder or alloys powder has a particle size of at least 100 nm. In some embodiments the iron powder or alloys powder has a particle size of at least 500 nm. In some embodiments the iron powder or alloys powder has a particle size of at least 1 micron. In some embodiments the iron powder or alloys powder has a particle size of at least 10 microns. In some embodiments, the particle size distribution is a bimodal distribution. In some embodiments, the purity of Iron powder or alloy powder is greater than 99%. In some embodiments, the purity of Iron powder or alloy powder is greater than 99.9%. In some embodiments, the purity of Iron powder or alloy powder is greater than 99.99%. In some embodiments, the purity of Iron powder or alloy powder is greater than 99.999%. In some embodiments, the Iron powder or the alloy powder so formed may be stored in a Hydrogen environment. In some embodiments, the Iron powder or the alloy powder may be fabricated in to parts using powder metallurgical processing steps of compacting and sintering. In some embodiments, the Iron powder or the alloy powder may be used to fabricate parts using 3D printing methods. In some embodiments the Iron powder or the alloy powder may be melted in an additional step (not shown) to obtain a molten Iron or the alloy. In some embodiments, the molten Iron or alloy can be cast into ingots or other shapes and resolidified.

The process steps 201 and 202 shown in FIG. 2 are similar to the process steps 101 and 102 respectively and their variations as described in previous sections. The process step 203 is quite similar to the process step 103 and its variations described in the previous sections. In step 203, Iron Ore is reacted with HCl to form Ferrous Chloride. In some embodiments, when Hematite ore is used, a solution of Ferric chloride is first formed in Step 203a. In some embodiments, when Magnetite ore is used, a mixture of Ferric and Ferrous ions are produced in step 203a. In some embodiments, the reaction 203(a) can be performed using at least one of sulfuric acid, nitric acid or any other acid which is stronger than hydrochloric acid.

In step 203b, the Ferric chloride solution is reduced to Ferrous Chloride with Iron Scrap, Steel scrap, Cast Iron, Steel alloy, iron powder, or a portion of the Iron powder output from step 205. In some embodiments, the Ferric ion in solution can be reduced to Ferrous ion in solution in step 203(b) by using at least one of sulfonyl chloride, Chlorobenzene as a reducing agent. In some embodiments, the Ferric ion in solution can be reduced to Ferrous ion in solution using other reducing agents. In some embodiments the reduction is done in an organic solvent. In some embodiments, the reduction is performed in Tetrahydrofuran (THF). In some embodiments the reduction of ferric ions to ferrous ions is done by electrochemical reduction. In some embodiments the reduction of ferric ions to ferrous ions is done in an electrochemical redox flow cell. In some embodiments the reaction 203(b) is performed in an oxygen free environment to keep the resultant ferrous ion from oxidizing back to ferric ion. In some embodiments the pH of the solution is maintained between 2 and 7 to prevent the oxidation of ferrous ion back to ferric ion. In some embodiments, when acids other than HCl are used, the reduction of ferric ion to ferrous ion in solution may be performed in the same way as that described above.

In some embodiments, the concentration of the HCl solution or the acid solution so used may be between 1 M and 0.01 M. In some embodiments, the reactions in step 203 may be performed at ambient temperature. In some embodiments, the reactions in step 203 may be performed at an elevated temperature. In some embodiments, the reactions in step 203 may be performed at a temperature about 30° C. and about 200° C. In some embodiments, the step 203 is performed as a leaching process where the HCl solution or the acid solution so used is poured on the oxide ore the most of the impurities such as Silica, alumina, sulfur, phosphorus, and other non-oxide impurities do not react with HCl to enter the solution phase and are therefore separated out by filtration system. In some embodiments, the reactions in step 203 are performed in an organic solvent.

While not shown in the FIG. 2, in some embodiments, the chloride ion can be replaced by another anion. In some embodiments the chloride ion may be replaced by a sulfate ion, nitrate ion, perchlorate ion or another anion of greater ionic strength than the chloride ion. Such anions can be replaced by adding the corresponding acid to the chloride solution of the metal cation and heating the solution to collect the hydrochloric acid as a vapor. In some embodiments, other anions can co-exist in solution with the chloride ion by addition of acid corresponding to the particular cation. In some embodiments, the pH of the solution can be adjusted to be lower than the 7. In some embodiments, the pH of the solution is between 2 and 7. In some embodiments, the additional anions added to the chloride solution of metal cation may be of lower strength than the chloride ion. In some embodiments, the additional anions may be added as a solution of corresponding acid. In some embodiments, the additional anion may be added as the metal salt of the anion with a metal. In some embodiments, the metal in the metal salt may be an alkali metal, an alkaline earth metal or a transition metal or a metal common to the metal of interest in the ore. In some embodiments, the chloride ion is partially or fully replaced by another anion by electrodialysis. In some embodiments the chloride ion may be replaced by the sulfate ion.

In process Step 204, the solution obtained in the Step 203 is converted to Ferrous Carbonate by reacting it with a solution of at least one of sodium carbonate, sodium bicarbonate or both as obtained from the Step 201. Embodiments and variations thereof are similar to those described in previous sections for Step 104. In some embodiments, an extra quantity of sodium carbonate, sodium bicarbonate or their combination may be added to the solution. In some embodiments, this reaction is carried out at temperature between about 25° C. and about 50° C. In some embodiments, this reaction is carried out at temperature between about 25° C. and about 100° C. In some embodiments, this reaction is carried out at temperature between about 25° C. and about 350° C. In some embodiments, this reaction is carried out at temperature between about 50° C. and about 300° C. In some embodiments, this reaction is carried out at temperature between about 100° C. and about 300° C. In some embodiments, this reaction is carried out at temperature between about 150° C. and about 300° C. In some embodiments, this reaction is carried out at temperature between about 100° C. and about 250° C. In some embodiments, this reaction is carried out at temperature between about 150° C. and about 250° C. In some embodiments, this reaction is carried out at temperature between about 150° C. and about 200° C. In some embodiment, the step 204 is carried out a temperature of at most 200° C. In some embodiment, the step 204 is carried out a temperature of at most 300° C. In some embodiment, the step 204 is carried out a temperature of at most 400° C. In some embodiment, the step 204 is carried out a temperature of at most 500° C. In some embodiment, the step 204 is carried out a temperature of at least 100° C. In some embodiment, the step 204 is carried out a temperature of at least 200° C. In some embodiment, the step 204 is carried out a temperature of at least 300° C. In some embodiments, the temperature is adjusted during step 204 to adjust the rate of the reaction. In some embodiments, the temperature is adjusted during step 204 to adjust the rate of the nucleation and growth of ferrous carbonate. In some embodiments, the temperature is adjusted during step 204 to adjust the rate of the nucleation and growth of the alloy carbonate of ferrous carbonate with another metal carbonate when a mixture of oxide ores (or oxides) of iron and other metals is used in Step 203 to produce metal alloy powders as end product after step 205. In some embodiments, the process step 204 is carried out in an organic solvent.

In some embodiments, the pH of the reaction mixture is between 2 and 7 for some metal chloride solutions to adjust (or increase) the rate of reaction and to suppress parasitic reactions. In some embodiments, the Ferrous Carbonate formed by the reaction is precipitated out from the solution. In some embodiments, the seed crystals of Ferrous carbonate are added to the reaction mixture to increase the rate of nucleation or growth or both, and hence increase the rate of the reaction. In some embodiments, the seed crystals of another material are added to the solution to achieve a higher rate of the reaction. In some embodiments, another organic or inorganic materials in solid, liquid or gaseous form may be added to the reaction vessel to impede the formation of non-carbonate precipitates during the reaction. For instance, ammonia may be bubbled through the solution. In some embodiments, a solution of sulfuric acid may be added to the reaction vessel to impede the formation of a metal hydroxide that may precipitate before the Ferrous carbonate or co-precipitate with the Ferrous Carbonate. In some embodiments, the Ferrous Carbonate precipitate may be filtered, washed and dried. In some embodiments, a portion of the Ferrous carbonate precipitate may be used as a seed crystal for another batch of the reaction. In some embodiment, the seed crystals may have an amorphous structure or a partial crystalline and amorphous nature. In some embodiments, the process step 204 is conducted in an oxygen-free environment to prevent the oxidation of Ferrous ion to Ferric ion. In some embodiments the pH in the reaction vessel is maintained at an acidic level to prevent the oxidation of a Ferrous ion to Ferric ion. In some embodiments, an inert gas such as N2, Ar or He may be bubbled through the reaction vessel during the reaction.

In many ores, limestone or dolomite are impurities in the ore which may enter the solution at Step 203 as Calcium or Magnesium Chloride respectively. However, the energetics of their reaction with sodium carbonate or bicarbonate may not be favorable enough at a meaningful rate at the range of conditions of step 204 to convert them back to insoluble precipitate. However, in some embodiments, impurities of at least one of CaCO3, MgCO3, SiO2, Carbon may be deliberately added to the solution in powder form at Step 204. In some embodiments, such impurities may be act as seed crystals for the precipitation of Ferrous Carbonate during step 204. In some embodiments, CaCO3 and MgCO3 may be added to adjust the pH of the solution during step 204. In some embodiments, such impurities may be added for further processing requirements during step 205 or purification of the Iron formed after step 105. In some embodiments, the carbon added to the solution may be amorphous carbon, nano-carbon, graphene, carbon nanotubes, fullerenes or other forms of carbon. In some embodiments, Zirconium Oxide or Yttrium oxide or Tungsten oxide micro- or nano-particles may be added to the reaction mixture as seed crystals or to aid further processing (in Step 205 or after step 205, not shown) or to control the properties of the Iron so produced. In some embodiments, oxide micro- or nano-particles of other metals such as Ca, Mg, Li, Si, Sr, Ba, K, Ti, V, Cr, Mn, Fe, Co, Ni, Cu, Zn, Zr, Mo, Nb, Ce B, Al, Sn etc. or their combinations thereof may be added as to the reaction mixture as seed crystals or to aid further processing (in Step 205 or after step 205, not shown) or to control the properties of the metals so produced. In some embodiments, the impurities act as nucleation and growth sites for Ferrous Carbonates formed in step 204. In some embodiments, these oxide or carbonate materials in nano-or micro-from may participate in the Step 205 as a catalyst or reactant. In some embodiments, the seed crystals are alloy carbonate particles of Iron with other metals such that there is atomic level mixing between the atoms of the elements constituting the alloy carbonate particles. In some embodiments, an alloy carbonate of Ferrous Carbonate with carbonate of other metals is formed when a mixture of oxide ores (or oxides) is in Step 203. In some embodiments, the alloy carbonate of Ferrous Carbonate with other metal carbonates has the similar relative ratio of metals as that intended to be in the final alloy composition prepared after step 205. In some embodiments, carbon may be incorporated in Ferrous Carbonate powder in the elemental form or as a compound during the step 204.

In some embodiments the Ferrous Carbonate so formed has a particle size in the range between about 1 nm and about 100 nm. In some embodiments the Ferrous Carbonate so formed has a particle size in the range between about 1 nm and about 500 nm. In some embodiments the Ferrous Carbonate so formed has a particle size in the range between about 1 nm and about 1 micron. In some embodiments the Ferrous Carbonate so formed has a particle size in the range between about10nm and about1micron. In some embodiments the Ferrous Carbonate so formed has a particle size in the range between about 100 nm and about 5 microns. In some embodiments the Metal Carbonate so formed has a particle size in the range between about 100 nm and about 10 microns. In some embodiments the Ferrous Carbonate so formed has a particle size in the range between 100 nm and 100 microns. In some embodiments the Ferrous Carbonate so formed has a particle size of at least 50 nm. In some embodiments the Ferrous Carbonate so formed has a particle size of at least 500 nm. In some embodiments the Ferrous Carbonate so formed has a particle size of at least 1 micron. In some embodiments the Ferrous Carbonate so formed has a particle size of at least 5 microns. In some embodiments the Ferrous Carbonate so formed has a particle size of at most 1 micron. In some embodiments the Ferrous Carbonate so formed has a particle size of at most 10 microns. In some embodiments the Ferrous Carbonate so formed has a particle size of at most 100 microns. In some embodiments, the particle size distribution is a bimodal distribution.

In Process step 205, the Ferrous carbonate prepared during the prior reaction step 204 is reduced to the metal using a reducing agent in a reactor or furnace. In some embodiments, H₂ is used as a reducing agent. In some embodiments, the reduction of the Ferrous Carbonate to Iron is done in a temperature range between about 200° C. and about 400° C. In some embodiments, the reduction of the Ferrous carbonate to Iron is done in a temperature range between about 200° C. and about 1000° C. In some embodiments, the reduction of the Ferrous Carbonate to Iron is done in a temperature range between about 200° C. and about 800° C. In some embodiments, the reduction of the Ferrous Carbonate to Iron is done in a temperature range between about 200° C. and about 700° C. In some embodiments, the reduction of the Ferrous Carbonate to Iron is done in a temperature range between about 200° C. and about 600° C. In some embodiments, the reduction of the Ferrous Carbonate to Iron is done in a temperature range between about 200° C. and about 500° C. In some embodiments, the reduction of the Ferrous Carbonate to Iron is done in a temperature range between about 500° C. and about 1500° C. In some embodiments, the reduction of the Ferrous Carbonate to Iron is done at a temperature of at least 200° C. In some embodiments, the reduction of the Ferrous Carbonate to Iron is done at a temperature of at least 300° C. In some embodiments, the reduction of the Ferrous Carbonate to Iron is done at a temperature of at least 400° C. In some embodiments, the reduction of the Ferrous Carbonate to Iron is done at a temperature of at least 200° C. In some embodiments, the reduction of the Ferrous Carbonate to Iron is done at a temperature of at most 500° C. In some embodiments, the reduction of the Ferrous Carbonate to Iron is done at a temperature of at least 600° C. In some embodiments, the reduction of the Ferrous Carbonate to Iron is done at a temperature of at least 700° C. In some embodiments, the reduction of the Ferrous Carbonate to Iron is done at a temperature of at least 800° C. In some embodiments, the reduction of the Ferrous Carbonate to Iron is done at a temperature of at least 900° C. In some embodiments, the reduction of Ferrous Carbonate to Iron is done at a temperature of at least 1000° C. In some embodiments, the temperature of the reduction of an alloy carbonate is intermediate to the temperature of reduction of metal carbonate with highest temperature and the temperature of reduction of metal carbonate with lowest temperature. In some embodiments, the temperature of the reduction of an alloy carbonate is lower than the lowest temperature of reduction of metal carbonate present in the alloy carbonate.

In some embodiments, at least one of Carbon Monoxide, Carbon, Coke, Coal, Methane, Ethane, Ethylene, Acetylene, Metal Hydride, Hydrogen can be used alone or in combination. In some embodiments, Hydrogen can be mixed with other reducing agents mentioned above to regulate the temperature range of the reduction reaction or to control the amount of heat generated/consumed in the reaction (for example, to convert the H₂ reduction of iron oxide from endothermic to exothermic). In some embodiments, other reducing agents can be mixed with H₂ in the concentration range between about 5% and about 95% of the total. In some embodiments, Carbon Monoxide is mixed with H₂ in the concentration range between about 5% and about 95% of the total. In some embodiments, Methane is mixed with H₂ in the concentration range between about 5% and about 95% total. In some embodiments Syngas is used as a reducing agent. In some embodiments Water Gas is used as a reducing agent. In some embodiments Ammonia is used as a reducing agent. When H₂ is used as a reducing agent, the reduction of Ferrous Carbonate can be shown by the equation: FeCO₃ + H₂ ➙ Fe + CO₂ + H₂O.

In some embodiments, the reduction reaction in step 205 is done at atmospheric pressure. In some embodiments the reduction reaction is done at pressures in the range between about 1 mPa to about 10⁴ kPa. In some embodiments the partial pressure of the reducing gases in the reaction can be varied. In some embodiments, the partial pressure of the reducing gas in the reaction is between about 1 mPa and about 1 Pa. In some embodiments, the partial pressure of the reducing gas in the reaction is between about 1 mPa and about 10 Pa. In some embodiments, the partial pressure of the reducing gas in the reaction is between about 1 mPa and about 100 Pa. In some embodiments, the partial pressure of the reducing gas in the reaction is between about 100 Pa and about 1 kPa. In some embodiments, the partial pressure of the reducing gas in the reaction is between about 100 Pa and about 5 kPa.

In some embodiments, the process shown in FIG. 2 is truncated at step 204 to store the metal carbonate as such. In some embodiments the metal carbonate so formed is stored in the same mine from where the metal oxide ore is mined. In some embodiments, the metal carbonate so stored can be used as a source of CO₂ at a later time by heating the metal carbonate, reacting the metal carbonate with an acid or through other chemical reactions or electrochemical reactions. The final carbon capture reaction becomes:

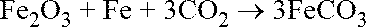

In the final step 206, the CO₂ and H₂O produced in the step 205 are separated from via partial or complete condensation of the water vapor. The resultant CO₂ after separation or the mixture of CO₂ and H₂O after partial separation is recycled back in to step 201 to make it a closed loop process. In some embodiments, the CO₂ and H₂O produced in step 205 is recycled back as such to reaction 201 making it a closed loop process. In some embodiments, additional CO₂ is mixed with output of step 205 to make up for any shortfall in the CO₂ required for the next cycle. In some embodiments, variations may be made to the closed loop process to add extra ingredients or emit extra by-products to make up for the shortfall or to vary the composition or reactants at various steps 201 to 205. The final, effective reaction for iron-making using this multi-step process is: Fe₂O₃ + 3H₂ ➙ 2Fe + 3H₂O

During Step 205, the reduction of Iron Carbonate forms Iron metal whereas any impurities of Calcium and Magnesium Carbonate from Step 204 are partially converted to Calcium and Magnesium oxide respectively. Another advantage of this process is that, due to lower temperature, Iron product after step 205 is in powdered form. Therefore, it can be either be formed directly into specific parts using powder metallurgical processing or melt and cast into parts as required. With this method of iron making, high purity iron powder or high purity iron alloy powder can be obtained. As a result, the need for traditional Basic Oxygen Process for removal of impurities is obviated. Therefore, only secondary metallurgical treatments of this iron product is needed to get to desired steel composition. Ton of castability: In a blast furnace operation, all raw materials (Iron Ore, Coke, fluxes etc) are heated up to the melting temperature of iron. This is a significant waste of energy because molten slag and high temperature effluent gases are low value by products. Therefore, in a typical blast furnace process followed by Basic Oxygen process for steel making, every ton of molten steel production needs melting of 4 tons raw materials. For the processes described in various embodiment of this disclosure, ~1 ton of raw materials are used to get roughly 1 ton of molten steel to be cast into products. Therefore, this is a highly energy efficient process.

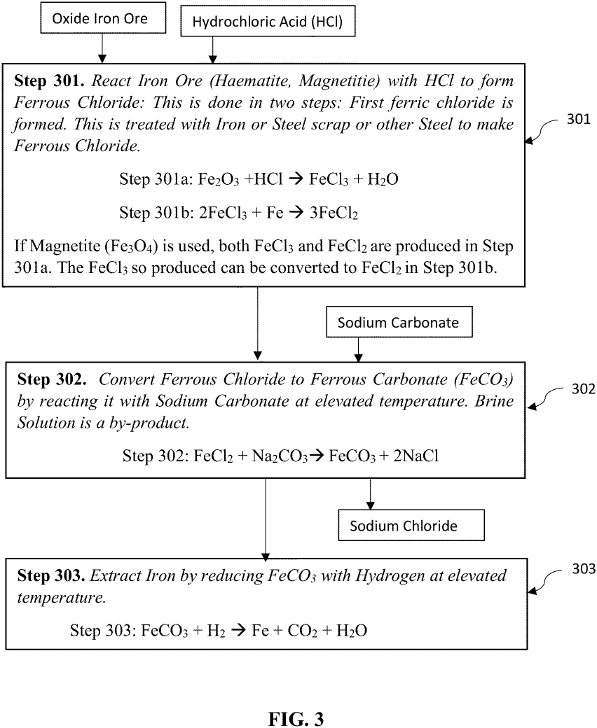

FIG. 3 shows a truncated version of the processes described in various embodiments of FIG. 1 and FIG. 2. Since this is not a closed loop process, HCl is an ingredient added to the step 301 while Sodium Carbonate (or Sodium Bicarbonate) is added to step 302. The process step 301 is similar to the process 103 and 203 and its various embodiments as described previously. The process step 303 is similar to the process 104 and 204 and its various embodiments as described previously. The process step 303 is similar to the process 105 and 205 and its various embodiments as described previously. In some embodiments, the CO₂ emitted during step 303 may be released into the atmosphere as such. In some embodiments, the CO₂ emitted during step 303 may be captured and stored using a carbon capture and sequestration method. In some embodiments, as-mined or processed Trona Rock (Na₂CO₃—NaHCO3^{—}2H₂O) may be used in Step 302 instead of place of Sodium Carbonate or Sodium Bicarbonate to convert Ferrous Chloride to Ferrous Carbonate. The reaction may be given as:

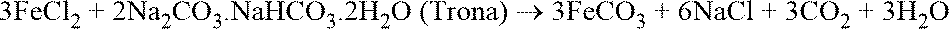

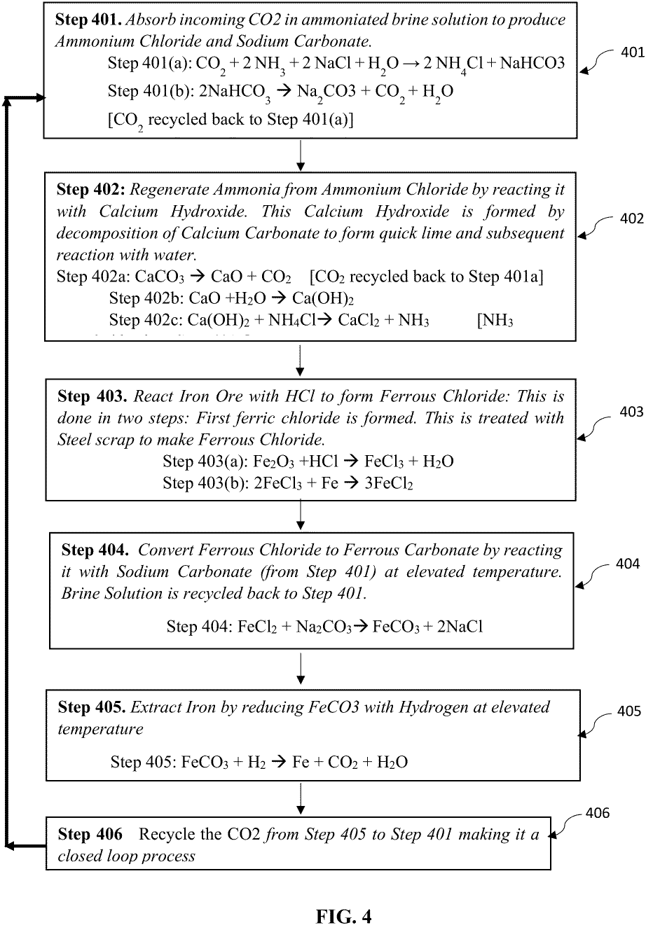

FIG. 4 shows a variation of the closed loop process for metal extraction shown in FIGS. 1 and 2. The step 401 is similar to process steps 101 and 201 and its various embodiments. Sep 402 differs from the steps 102 and 202. In step 402, Ammonium Chloride is reacted with Calcium Carbonate to release and recycle Ammonia back to step 401. Since no free HCl is generated in Step 401, HCl is added separately in step 403. Step 403 is similar to Steps 103 and 203 and its various embodiments described in previous sections. Step 404 is similar to Steps 104 and 204 and its various embodiments described in previous sections. Step 405 is similar to Steps 105 and 205 and its various embodiments described in previous sections. Step 406 is similar to Steps 106 and 206 and its various embodiments described in previous sections.

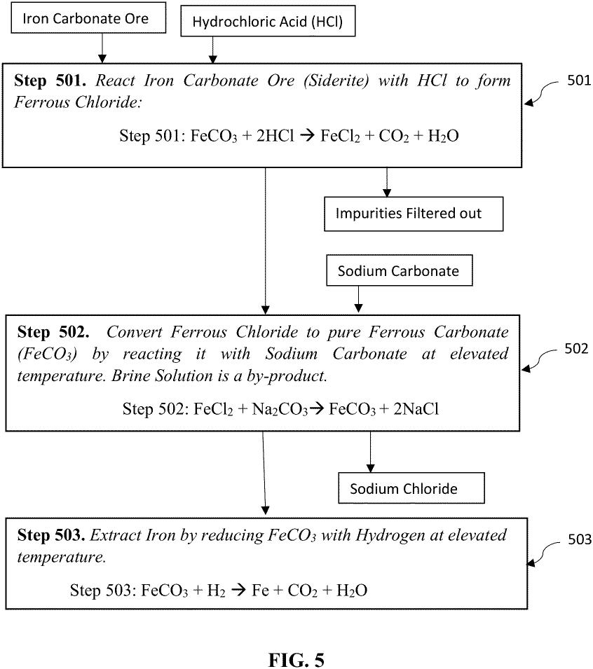

FIG. 5 shows a variation of the process shown in FIG. 3. In some embodiments of this process, Siderite Ore (Ferrous Carbonate) is used in step 501 to produce Ferrous Chloride by reacting it HCl. Step 501 helps separate impurities in the Siderite ore and bring Ferrous ions in solution. In some embodiments, other acids including, but no limited to, sulfuric acid, nitric acid, perchloric acid may be used. The Ferrous ions in solution are then precipitated out in Step 502 as Ferrous Carbonate by reacting the solution with at least one of Sodium Carbonate or BiCarbonate. Step 502 is similar to process steps 105 and 504 and their various embodiments described in previous sections. In some embodiments, as-mined or processed Trona Rock (Na₂CO_{3*}NaHCO_{3*}2H₂O) may be used in Step 502 instead of place of Sodium Carbonate or Sodium Bicarbonate to convert Ferrous Chloride to Ferrous Carbonate. In some embodiments, Step 501 may be skipped completely and Ferrous Sulfate may be used in step 502 to react with at least one of Sodium Carbonate or Sodium Bicarbonate. In this case as well, step 502 is similar to steps 104 and 204 and their various embodiments as described in previous sections. In some embodiments, as-mined or processed Trona Rock (Na₂CO_{3*}NaHCO_{3*}2H₂O) may be used in Step 502 to convert Ferrous Sulfate to Ferrous Carbonate, wherein the impurities in as-mined or as-processed do not impede the rate of reaction. In some embodiments, Sulfuric acid may be added to the Ferrous sulphate or Ferrous Chloride solution to lower the pH and prevent the oxidation of Ferrous ion to Ferric ion. In some embodiments, the step 502 is performed in an oxygen free environment. The Ferrous Carbonate so formed is reduced in Step 503 to form Iron. The step 503 is similar to steps 105 and 205 and their various embodiments as described is previous sections. In some embodiments, the CO₂ emitted during step 303 may be captured and stored using a carbon capture and sequestration method.

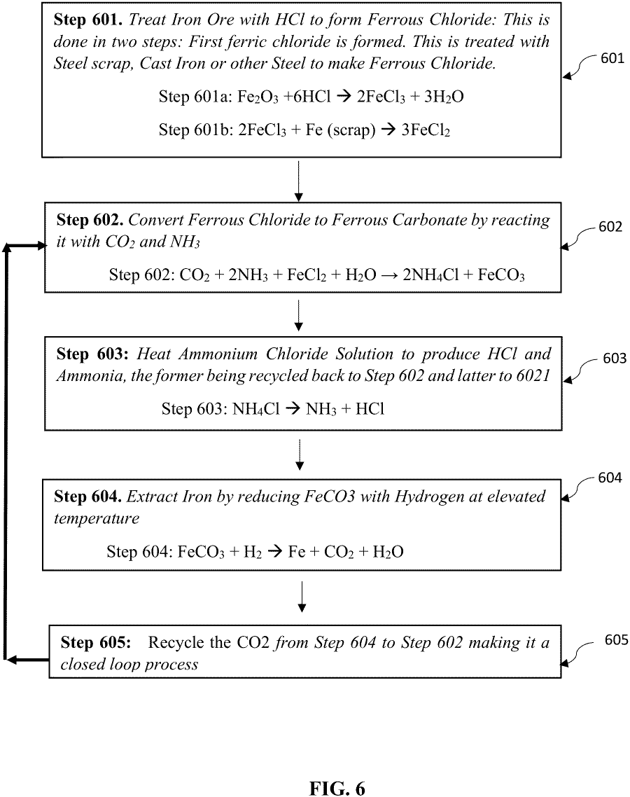

FIG. 6 shows an alternate method for the production of Iron from the oxide ores of Iron. The step 601 is similar to the steps 103 and 203 and their various embodiments as described in previous section. The Ferrous Chloride solution from step 601 is converted to form Ferrous Carbonate by passing CO₂ and ammonia at elevated temperature in step 602. In some embodiments, Sodium Chloride is added to the Ferrous Chloride solution to aid the dissolution of Ammonia in the solution. In some embodiments, ionic liquid salts are added to the Ferrous Chloride solution to aid the dissolution of CO₂. In some embodiments the ionic liquid is a imidazolium based ionic liquid. In some embodiments, the Ferrous Carbonate so formed has characteristics similar to Ferrous Carbonate obtained by other processes and their embodiments described in previous sections of the disclosure. In some embodiments, the reaction occurs at room temperature under pressures greater than atmospheric pressure.

The Ammonium Chloride so formed in step 602 is separated into Ammonia and HCl in step 603. Ammonia is recycled to step 602 while HCl is recycled to step 601 The step 603 is similar to steps 102 and 202 and their various embodiments as described in previous sections. The Ferrous Carbonate formed in step 602 is reduced to Iron in Step 604. The Step 604 is similar to steps 105 and 205 and their various embodiments as described in previous sections. In step 605, the CO₂ formed in the step 604 is recycled back into Step 602. The Step 605 is similar to steps 106 and 206 and their various embodiments as described in previous sections. While the processes shown in FIGS. 3-6 are shown for extraction of Iron, they may be used for extraction/production of other metals and/or alloys based on various embodiments in the disclosure.

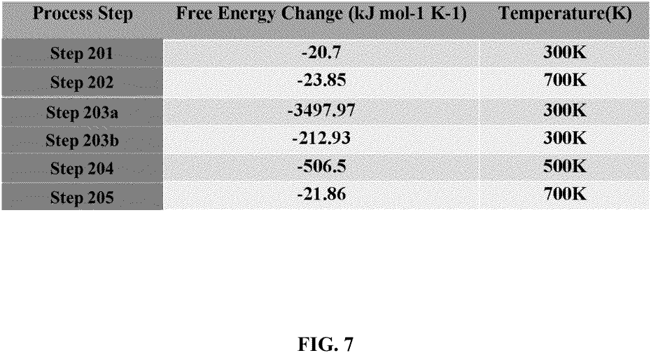

FIG. 7 shows thermochemical data for various steps 201 to 205 as described in previous sections of this disclosure. All the process steps have a negative free energy change at corresponding temperatures shown in the third column from the left.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order or execution, but rather, any number of threads, processes, services, servers, and/or the like may execute serially, asynchronously, concurrently, in parallel, simultaneously, synchronously, and/or the like in a manner consistent with the disclosure. As such, some of these features may be mutually contradictory, in that they cannot be simultaneously be present in the single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration, and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of′ or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of′ and “consisting essentially of′ shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A method of metal extraction, the method comprising:
reacting an oxide ore of a metal with an acid solution to form a soluble product comprising metal ions in aqueous solution;
converting higher valent metal ions in solution to lower valent metal ions in solution via a reduction reaction;
precipitating the lower valent ions in solution to form an insoluble metal carbonate; and
reducing the insoluble metal carbonate to the metal.

2. The method of claim 1, wherein the acid solution is at least one of hydrochloric acid, sulfuric acid or nitric acid.

3. The method of claim 1, wherein the higher valent ions in solution are reduced to the lower valent ions in solution by a chemical reduction in solution or electroreduction in a redox flow cell.

4. The method of claim 1, wherein the lower valent cation is precipitated to form the insoluble metal carbonate by reacting it with at least one of sodium carbonate, sodium bicarbonate, as-mined or processed trona rock, or a combination thereof.

5. The method of claim 1, wherein the reduction of the insoluble metal carbonate to the respective metal is performed by reaction at elevated temperature with at least one of hydrogen, carbon monoxide, carbon, methane, hydrogen plasma, plasma reformed methane or a combination thereof.

6. The method of claim 1, wherein the reduction of the insoluble metal carbonate is performed at a temperature between about 300° C. and about 700° C.

7. The method of claim 1, wherein the method is a closed loop process.

8. The method of claim 1, wherein the metal formed by reduction of the insoluble metal carbonate is a metal powder in the form of microparticles or nanoparticles having a spherical morphology or an irregular morphology.

9. A method for extraction of Iron, the method comprising:
reacting an oxide ore of iron with an acid solution to form a soluble product comprising ferric ions in aqueous solution;
converting the ferric ions in solution to ferrous ions in solution via a reduction reaction;
precipitating the ferrous ions in solution to form an insoluble ferrous compound;
reducing the insoluble ferrous compound to solid iron.

10. The method of claim 9, wherein the acid solution is at least one of hydrochloric acid, sulfuric acid or nitric acid.

11. The method of claim 9, wherein the solution of ferric ion is reduced to a solution of ferrous ion by reacting it with iron in an acidic environment.

12. The method of claim 11, wherein the iron used is scrap iron.

13. The method of claim 9, wherein the solution of ferric chloride is reduced to a solution of ferrous chloride by reacting it with at least one of sulfur monochloride or chlorobenzene.

14. The method of claim 9, wherein the solution of ferric ion is reduced to a solution of ferrous ion by electrochemical reduction in a redox flow cell.

15. The method of claim 9, wherein the insoluble ferrous compound is ferrous carbonate.

16. The method of claim 9, wherein the ferrous ion in solutions is precipitated to form the insoluble ferrous compound by reacting it with at least one of sodium carbonate, sodium bicarbonate, as-mined or processed trona rock, or a combination thereof.

17. A method of claim 9, wherein the insoluble ferrous compound is precipitated from solution by adding seed crystals of at least one of metal oxide, metal carbonate, ferrous carbonate, or carbon.

18. The method of claim 9, wherein the reduction of the insoluble compound to the respective metal is performed by reaction with at least one of hydrogen, carbon monoxide, carbon, methane, hydrogen plasma, plasma reformed methane or a combination thereof.

19. The method of claim 9, wherein the reduction of the ferrous carbonate is performed at a temperature between about 300° C. and about 700° C.

20. The method of claim 9, wherein the method is a closed loop process such that the byproducts and intermediates are recycled.

21. The method of claim 9, wherein the iron formed by reduction of insoluble ferrous compound is powdered iron in the form of microparticles or nanoparticles having a spherical morphology or irregular morphology.

22. The method of claim 9, wherein the iron formed by reduction of insoluble ferrous compound is melted and cast into ingots and other products.

23. A method of forming metal alloys from ores, the method comprising:
mixing ores of different metals in a predetermined ratio to form a mixed ore;
reacting a predetermined quantity of ores of different metals with an acid solution to form a soluble product comprising metal ions of different metals in an aqueous solution;
converting the higher valent metal ions in solution to lower valent metal ions in solution via a reduction reaction;
precipitating the lower valent metal ions of different metals in solution to form insoluble mixed metal carbonate; and
reducing the alloy of insoluble mixed metal carbonate to form a metal alloy.

24. A method of claim 23, wherein the acid solution is at least one of hydrochloric acid, sulfuric acid or nitric acid.

25. A method of claim 23, wherein the higher valent metal ions in solution are reduced to the lower valent metal ions in solution by a chemical reduction in solution or electrochemical reduction in a redox flow cell.

26. A method of claim 23, wherein the lower valent cation is precipitated to form the insoluble mixed metal carbonate by reacting it with at least one of sodium carbonate, sodium bicarbonate, as-mined or processed trona rock or a combination thereof.

27. The method of claim 23, wherein the reduction of the insoluble mixed metal carbonate alloy to the metal alloy is performed by reaction at elevated temperature with at least one of hydrogen, carbon monoxide, carbon, methane, hydrogen plasma, plasma reformed methane or a combination thereof.

28. The method of claim 23, wherein the reduction of the mixed metal carbonate is performed at a temperature between about 300° C. and about 700° C.

29. The method of claim 23, wherein the method is a closed loop process.

30. The method of claim 23, wherein the metal alloy formed by reduction of insoluble mixed metal carbonate compound is powdered iron in the form of microparticles or nanoparticles having a spherical morphology or irregular morphology.

31. The method of claim 23, wherein both the insoluble mixed metal carbonate and the metal alloy have atomic level of mixing of different metal elements.
